(19) United States
(12) Patent Application Publication
(10) Pub. No.: US 2026/0008120 A1
(43) Pub. Date: Jan. 8, 2026

(54) LASER APPARATUS AND LASER PROCESSING MACHINE

(71) Applicant: Mitsubishi Electric Corporation, Tokyo (JP)

(72) Inventors: Tomohiro KYOTO, Tokyo (JP); Masato KAWASAKI, Tokyo (JP); Hiroshi KIKUCHI, Tokyo (JP); Daisuke MORITA, Tokyo (JP)

(73) Assignee: Mitsubishi Electric Corporation, Tokyo (JP)

(21) Appl. No.: 19/123,079

(22) PCT Filed: Apr. 24, 2023
(86) PCT No.: PCT/JP2023/016034

§ 371 Date: Apr. 22, 2025

(51) Int. Cl. B23K 26/06; B23K 26/12

(52) U.S. Cl. CPC B23K 26/0604; B23K 26/0643; B23K 26/12

(57) ABSTRACT

A laser apparatus includes: a laser module that outputs laser beams; and a beam combining module that combines the laser beams into a combined beam as a laser beam having a single optical axis, the laser module including laser beam sources, first transmission optical systems, and a first box. The plurality of first transmission optical systems shape the laser beams into parallel light or a state close to parallel light. The first box houses the laser beam sources and the first transmission optical systems, and has sealed interior with a window through which the laser beams output from the laser beam sources pass. The first box is detachable from the beam combining module. At least one of the first box and the beam combining module includes a positioning member that positions the first box with respect to the beam combining module.

### FIELD

The present disclosure relates to a laser apparatus that outputs laser light and a laser processing machine.

### BACKGROUND

Conventionally, a laser apparatus that outputs a high-powered laser beam has been proposed. Patent Literature 1 discloses a laser apparatus including a first housing that houses a plurality of laser modules having laser diodes and a second housing that houses a combining optical system for combining laser beams from the plurality of laser modules. In the laser apparatus described in Patent Literature 1, for each of the laser modules, a fast axis collimator and a polarizing plate are provided in the first housing, and a slow axis collimator is provided in the second housing. The first housing and the second housing are provided in contact with each other, and a port for communication is provided for each of the laser modules at a position through which the laser beam output from the laser module passes. Moreover, the communication port is provided with a window.

### CITATION LIST

### Patent Literature

Patent Literature 1: Japanese Patent Application Laid-open No. 2019-192756

### SUMMARY OF INVENTION

### Problem to be Solved by the Invention

Now, the higher the output of the laser diode, the more easily the laser diode is affected by the surrounding environment such as dust. Therefore, typically, measures such as sealing the periphery of the laser diode are taken in order to not contaminate especially an emitting end face of the laser diode. In particular, at the time of component replacement, the surrounding environment is often poor due to dust floating in the air or the like, and it is necessary to contrive to reduce this influence. However, the aforementioned conventional technique has had a problem that the configuration of the laser module does not take into consideration the influence of the surrounding environment such as dust. In addition, when the laser apparatus is installed on a laser processing machine, it is required to reduce the time of component replacement in order to reduce the machine downtime. In the aforementioned conventional technique, a transmission optical system including the fast axis collimator, the polarizing plate, and the slow axis collimator for transmitting the laser beam output from the laser module to the combining optical system in the second housing is distributed and sealed in the first housing and the second housing for each of the laser modules. Thus, when a set of components in the first housing is replaced, each of the optical components of the transmission optical system distributed in the first housing and the second housing needs to be adjusted, which has led to a problem that the time of component replacement cannot be reduced as the replacement work cannot be performed smoothly.

The present disclosure has been made in view of the above, and an object of the present disclosure is to provide a laser apparatus capable of reducing the influence of the surrounding environment on a laser module at the time of component replacement and reducing the time of component replacement as compared to the conventional technique.

### Means to Solve the Problem

In order to solve the above problem and achieve the object, a laser apparatus of the present disclosure includes: a laser module that outputs a plurality of laser beams; and a beam combining module that combines the plurality of laser beams into a combined beam as a laser beam having a single optical axis, the laser module including a plurality of laser beam sources, a plurality of first transmission optical systems, and a first box. The plurality of laser beam sources outputs the laser beams. Each of the plurality of first transmission optical systems is provided for corresponding one of the plurality of laser beam sources, and shapes each of the laser beams output from the plurality of laser beam sources into parallel light or a state close to parallel light. The first box houses the plurality of laser beam sources and the plurality of first transmission optical systems, and has sealed interior with a window through which the laser beams output from the plurality of laser beam sources pass. The first box is detachable from the beam combining module. At least one of the first box and the beam combining module includes a positioning member that positions the first box with respect to the beam combining module.

### Effects of the Invention

The laser apparatus according to the present disclosure is capable of reducing the influence of the surrounding environment on the laser module at the time of component replacement and reducing the time of component replacement as compared to the conventional technique.

### BRIEF DESCRIPTION OF DRAWINGS

FIG. 1 is a diagram schematically illustrating an example of a configuration of a laser apparatus according to a first embodiment.

FIG. 2 is a diagram schematically illustrating an example of a configuration of a laser apparatus according to a second embodiment.

FIG. 3 is a diagram schematically illustrating another example of a configuration of the laser apparatus according to the second embodiment.

FIG. 4 is a diagram schematically illustrating an example of a configuration of a laser processing machine according to a third embodiment.

### DESCRIPTION OF EMBODIMENTS

Hereinafter, a laser apparatus and a laser processing machine according to embodiments of the present disclosure will be described in detail with reference to the drawings.

### First Embodiment

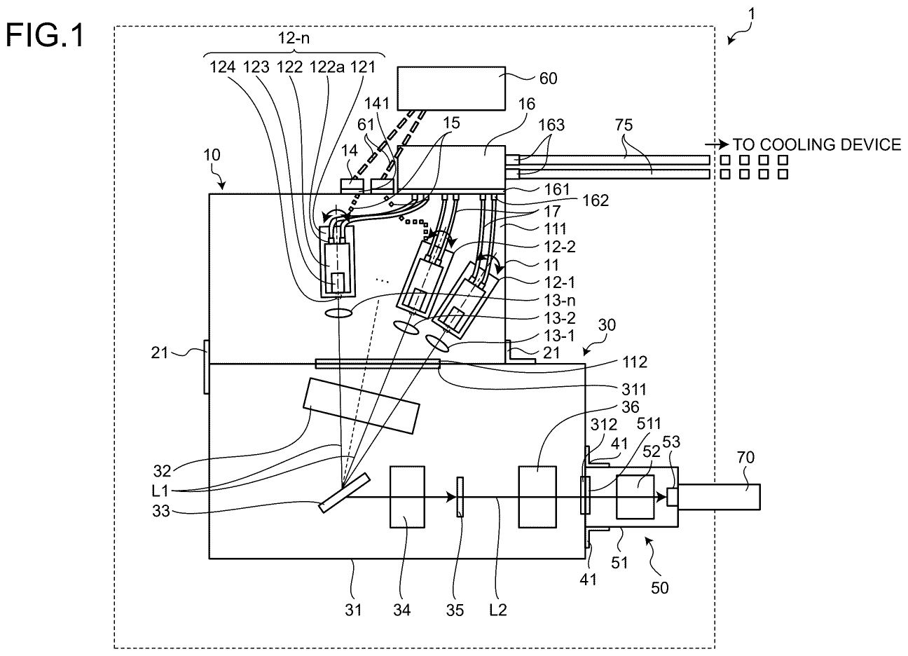

FIG. 1 is a diagram schematically illustrating an example of a configuration of a laser apparatus according to a first embodiment. A laser apparatus 1 includes a laser module 10 that outputs a plurality of laser beams L1, a beam combining module 30 that combines the plurality of the laser beams L1 output from the laser module 10 into a combined beam L2 that is a laser beam having a single optical axis, a fiber coupling module 50 that couples the combined beam L2 to a transmission fiber 70 that is an optical fiber, and a laser diode driving power supply 60 that drives laser diode (LD) elements of the laser module 10. In the first embodiment, the laser module 10, the beam combining module 30, and the fiber coupling module 50 each have a structure with sealed interior. Moreover, the laser module 10, the beam combining module 30, and the fiber coupling module 50 are each detachable from each other.

The laser module 10 includes a box 11, a plurality of LD packages 12-1, 12-2, . . . , and 12-n , a plurality of first transmission optical systems 13-1, 13-2, . . . , and 13-n , power feeding units 14, wires 15, a manifold 16, and pipes 17. Note that character “n” is an integer of two or more. Also, in the following description, the plurality of the LD packages 12-1, 12-15 2, . . . , and 12-n will be referred to as LD packages 12 when not individually distinguished. Similarly, the plurality of the first transmission optical systems 13-1, 13-2, . . . , and 13-n will be referred to as first transmission optical systems 13 when not individually distinguished.

The box 11 is a box-shaped member that houses the plurality of the LD packages 12 and the plurality of the first transmission optical systems 13. In this example, the box 11 has a hollow rectangular parallelepiped shape. The box 11 has a configuration in which its interior is kept airtight. The box 11 includes therein an installation base 111 where the plurality of the LD packages 12 and the plurality of the first transmission optical systems 13 are installed. The installation base 111 has reference shaft placement holes at positions where the LD packages 12 are installed. The reference shaft placement hole is a hole into which a reference shaft 124 having a rod shape described later is inserted. A surface of the installation base 111 on which the LD packages 12, the first transmission optical systems 13, and the like are installed is referred to as an installation surface.

The box 11 has, on its side surface in contact with the beam combining module 30, an opening at a position where the laser beams L1 output from the plurality of the LD packages 12 go outside. The box 11 includes, in the opening, a window 112 that is sealed. A seal member (not illustrated) is provided between an edge of the opening of the box 11 and an outer peripheral portion of the window 112. In one example, an O-ring as an example of the seal member is placed on the outer peripheral portion of the window 112 through which the laser beams L1 do not pass, whereby the opening of the box 11 is sealed. As a result, leakage or inflow of gas through a gap between the box 11 and the window 112 can be prevented, and the interior of the box 11 can be kept airtight. The window 112 is made of a material through which the laser beams L1 output from the LD packages 12 can pass. Although not illustrated, the box 11 has an opening for passing the wires 15 at a position where the power feeding units 14 are provided, and an opening for passing the pipes 17 at a position where the manifold 16 is provided. The box 11 corresponds to a first box.

The LD package 12 is a package that is fixed to the installation base 111 inside the box 11 and outputs the laser beam L1 having a predetermined wavelength. The plurality of the LD packages 12 is disposed in the laser module 10 and outputs the laser beams L1 having different wavelengths from each other. The LD package 12 is positioned on the installation base 111 and fixed on the installation base 111 by inserting the reference shaft 124 into both the reference shaft placement hole provided in advance in the installation base 111 and a reference shaft placement hole provided on a back surface of the LD package 12.

The LD package 12 includes an adjustment member 121, a heat sink 122, an LD bar 123, and the reference shaft 124.

The adjustment member 121 is a member on which the LD bar 123 is placed and fixed such that the laser beam L1 is emitted in a predetermined direction. The adjustment member 121 includes, on its back surface, the reference shaft placement hole into which the reference shaft 124 is inserted in a direction perpendicular to an installation surface of the adjustment member 121. The back surface of the adjustment member 121 is a surface in contact with the installation surface of the installation base 111. The adjustment member 121 is fixed to the installation base 111 such that the reference shaft 124 is inserted into both the reference shaft placement hole of the adjustment member 121 and the reference shaft placement hole of the installation base 111. As a result, the adjustment member 121 is fixed while being positioned on the installation base 111. The reference shaft placement hole in the adjustment member 121 is provided at an end on the side where the laser beam L1 is output, and the installation base 111 is rotatable about the reference shaft 124 in the plane of the installation surface. That is, when the adjustment member 121 is rotated about the reference shaft 124 in the plane of the installation surface, the direction of emission of the laser beam L1 can be changed.

The heat sink 122 is a heat dissipation member for preventing or reducing a temperature rise of the LD bar 123, and is fixed on the adjustment member 121. Inside the heat sink 122, a flow path through which a cooling medium flows is provided. In one example, the heat sink 122 includes a pipe connection portion 122a at an end on a side opposite to the side where the laser beam L1 is output. The pipe connection portion 122a is connected to the pipe 17 connected to the manifold 16.

The LD bar 123 is a structure including an LD element that outputs the laser beam L1, and a cathode electrode and an anode electrode that supply power to the LD element, and is fixed on the heat sink 122. The LD element is an edge emitting laser that emits the laser beam L1 in the direction of the first transmission optical system 13. Among side surfaces of the LD element, the side surface facing the side of the window 112 of the box 11 is an emitting end face from which the laser beam L1 is emitted. The side surface on a side opposite to the emitting end face is a reflecting end face that reflects the laser beam L1. In one example, the LD element uses gallium arsenide (GaAs) as a substrate and uses indium gallium arsenide (InGaAs) as an active layer. The LD bar 123 is the same as a laser diode bar.

The reference shaft 124 fixes the adjustment member 121 at a predetermined position on the installation base 111. In one example, the reference shaft 124 is provided in alignment with the position of the emitting end face of the LD bar 123.

The LD package 12 fixed to the installation base 111 via the reference shaft 124 rotates the adjustment member 121 about the reference shaft 124 in the plane of the installation surface of the installation base 111, thereby adjusting an optical axis of the laser beam L1 output from the LD bar 123. That is, the LD package 12 has a structure that is rotatable about the emitting end face when adjusting the direction of the optical axis of the laser beam L1 emitted from the emitting end face. Note that the LD package 12 including the LD bar 123 corresponds to a laser beam source that outputs a laser beam.

The first transmission optical system 13 is an optical element that is fixed to the installation base 111 inside the box 11 at a predetermined distance from the emitting end face of the LD bar 123, is provided for a corresponding one of the plurality of the LD packages 12, and performs optical axis adjustment of the laser beam L1 output from the LD package 12. In one example, the first transmission optical system 13 shapes the laser beam L1 output from the LD package 12 into parallel light or a state close to parallel light. In one example, the first transmission optical system 13 includes a fast axis collimator (FAC) and a slow axis collimator (SAC). The FAC is an optical component that collimates a fast axis component of the laser beam L1 emitted from the LD bar 123 of the LD package 12. The SAC is an optical component that collimates a slow axis component of the laser beam L1. Note that the first transmission optical system 13 may include other optical elements such as a polarizing plate that hardly requires optical axis adjustment. The FAC corresponds to a first optical component, and the SAC corresponds to a second optical component.

In the conventional technique, the FAC and the SAC are disposed in separate boxes so that when optical axis is adjusted for replacing the LD bar or the like, both of the box housing the FAC and the box housing the SAC need to be opened to conduct work. However, in the first embodiment, the FAC and the SAC are collectively disposed inside the box 11 constituting the laser module 10. Thus, since the FAC and the SAC are collectively disposed in one box 11, when optical axis is adjusted on the LD package 12 at assembling the laser module 10, the work need only be conducted in the single box 11 and is easier than that conventionally performed.

The power feeding unit 14 is a component that relays the wire 15 that supplies the power from the LD driving power supply 60 to the LD bar 123 of the LD package 12. The power feeding unit 14 is connected at the position of the opening (not illustrated) provided in the box 11 via a seal member 141 such as a gasket. A hermetic component can be used for the power feeding unit 14. Thus, the LD driving power supply 60 and the LD bar 123 can be connected by a wire 61 and the wire 15. When the laser module 10 is detached, it is sufficient that the wire 61 on the outside is detached from the power feeding unit 14. Note that, for simplification of description, FIG. 1 illustrates only two of the power feeding units 14, but the power feeding units 14 enough in number to be able to supply the power from the LD driving power supply 60 to the LD bars 123 via the wires 61 and 15 are provided.

The wires 15 electrically connect the power feeding units 14 and the LD bars 123 of the LD packages 12 inside the box 11. The wires 15 supply the power from the LD driving power supply 60 described later to the LD bars 123.

The manifold 16 is a relay member including flow paths for supplying the cooling medium to the heat sinks 122 of the LD packages 12. The manifold 16 is connected to the outside of the box 11 via a seal member 161 such as a gasket, and includes the flow paths branched so as to supply the cooling medium from a cooling device (not illustrated) to the heat sinks 122 of the LD packages 12, and flow paths joined so as to collectively return the cooling medium returning from the heat sinks 122 of the LD packages 12 to the cooling device. The manifold 16 includes, on its side surface connected to the box 11, a plurality of pipe connection portions 162 corresponding to the heat sinks 122 of the LD packages 12. The pipe connection portions 162 are connected to the pipe connection portions 122a of the LD packages 12 via the pipes 17. Note that, on the side surface of the box 11 to which the manifold 16 is attached, the opening (not illustrated) is provided so as to include all the pipe connection portions 162. Then, the manifold 16 is connected to the box 11 via the seal member 161 provided along an outer peripheral portion of the opening. As a result, the manifold 16 and the box 11 are sealed. Since the manifold 16 is provided so as to cover the opening with the seal member 161 interposed therebetween, the manifold 16 can also be regarded as a part of the component that seals the box 11. The manifold 16 also includes pipe connection portions 163 connected to pipes 75 extending from the cooling device. For detaching the laser module 10, it is sufficient that the pipes 75 connected to the cooling device are detached from the pipe connection portions 163.

The pipes 17 connect the pipe connection portions 162 of the manifold 16 and the pipe connection portions 122a of the heat sinks 122 of the LD packages 12 inside the box 11, and serve as flow paths through which the cooling medium flows. Since the position of the LD package 12 is adjustable around the reference shaft 124, the pipe 17 desirably has a flexible structure such as a hose.

The beam combining module 30 includes a box 31, a wavelength dispersion element 33, and a partially reflective mirror 35.

The box 31 is a box-shaped member that houses the wavelength dispersion element 33 and the partially reflective mirror 35. In this example, the box 31 has a hollow rectangular parallelepiped shape. The box 31 has a configuration in which its interior is kept airtight. The box 31 includes an opening on a side surface in contact with the box 11 of the laser module 10. The box 31 includes, in the opening, a window 311 that is sealed. The position of the window 311 is matched with the position of the window 112 of the box 11 of the laser module 10. A seal member (not illustrated) is provided between an edge of the opening of the box 31 and the window 311. Through the window 311, the laser beams L1 output from the laser module 10 enter. The window 311 is made of a material through which the laser beams L1 can pass.

The box 31 includes an opening on a side surface in contact with the fiber coupling module 50. The box 31 includes, in the opening, a window 312 that is sealed. A seal member (not illustrated) is provided between an edge of the opening of the box 31 and the window 312. The window 312 is made of a material through which the combined beam L2 can pass. The box 31 corresponds to a second box.

The wavelength dispersion element 33 combines the laser beams L1 emitted from a plurality of the laser modules 10 and having different wavelengths into one combined beam L2 having a single optical axis. Or, the wavelength dispersion element 33 separates the one combined beam L2 reflected by the partially reflective mirror 35 into a plurality of the laser beams L1 traveling to the respective laser modules 10 in a state where the directions of the optical axes are different from each other. An example of the wavelength dispersion element 33 is a prism, a diffraction grating, or the like.

The partially reflective mirror 35 transmits a part of the combined beam L2 combined by the wavelength dispersion element 33 and reflects the rest toward the laser module 10. The partially reflective mirror 35 constitutes an external optical resonator with the plurality of the LD bars 123 of the laser module 10. That is, the external optical resonator is formed between the partially reflective mirror 35 and the reflecting end faces, which are surfaces on the side opposite to the emitting end faces, of the LD bars 123, and a part of the combined beam L2 amplified by the external optical resonator is output to the outside from the partially reflective mirror 35. The resonator that oscillates the laser beams L1 with such a configuration is referred to as a wavelength beam combining (WBC) resonator.

In the example of FIG. 1, the beam combining module 30 includes a second transmission optical system 32, a third transmission optical system 34, and a fourth transmission optical system 36. The second transmission optical system 32, the third transmission optical system 34, and the fourth transmission optical system 36 are housed inside the box 31.

The second transmission optical system 32 is disposed between the laser module 10 and the wavelength dispersion element 33, and has a function of shaping the laser beams L1 incident on the wavelength dispersion element 33. In one example, the second transmission optical system 32 collimates the laser beams L1. An example of an element constituting the second transmission optical system 32 is a lens. The polarizing plate may be disposed not in the first transmission optical system 13 but in the second transmission optical system 32. The second transmission optical system 32 is provided as necessary.

The third transmission optical system 34 is disposed between the wavelength dispersion element 33 and the partially reflective mirror 35, and has a function of shaping the combined beam L2 emitted from the wavelength dispersion element 33 and incident on the partially reflective mirror 35. In one example, the third transmission optical system 34 shapes the combined beam L2 to have appropriate beam diameter and divergence angle. An example of an element constituting the third transmission optical system 34 is a lens group of one or more lenses. The third transmission optical system 34 is provided as necessary.

The fourth transmission optical system 36 is disposed at a subsequent stage of the partially reflective mirror 35, and has a function of shaping the combined beam L2 emitted from the partially reflective mirror 35 and incident on the fiber coupling module 50. In one example, the fourth transmission optical system 36 shapes the combined beam L2 to have appropriate beam diameter and divergence angle. Although FIG. 1 illustrates an example in which one laser module 10 is connected to the beam combining module 30, a plurality of the laser modules 10 are connected to the beam combining module 30 in other cases. In such a case, the fourth transmission optical system 36 has a function of changing the positions of the combined beams L2 from the laser modules 10 to predetermined positions. As an example of changing the positions of the combined beams L2, the combined beams L2 from the plurality of the laser modules 10 are placed at predetermined distances apart in a plane perpendicular to the direction of travel of the combined beams L2. Alternatively, in another example, a plurality of the partially reflective mirrors 35 is provided corresponding to the plurality of the laser modules 10, and the combined beams L2 from the plurality of the partially reflective mirrors 35 are further combined into one combined beam L2. An example of an element constituting the fourth transmission optical system 36 is a lens group of one or more lenses. The fourth transmission optical system 36 is provided as necessary.

The fiber coupling module 50 includes a box 51 and a fifth transmission optical system 52.

The box 51 is a box-shaped member that houses the fifth transmission optical system 52. In this example, the box 51 has a hollow rectangular parallelepiped shape. The box 51 has a configuration in which its interior is kept airtight. The box 51 includes an opening on a side surface in contact with the beam combining module 30. The box 51 includes, in the opening, a window 511 that is sealed. The position of the window 511 is matched with the position of the window 312 of the box 31 of the beam combining module 30. A seal member (not illustrated) is provided between an edge of the opening of the box 51 and the window 511. The combined beam L2 from the beam combining module 30 enters through the window 511. The window 511 is made of a material through which the combined beam L2 can pass. The box 51 includes a fiber joining portion 53 to which the transmission fiber 70 is connected.

The fifth transmission optical system 52 is an optical system that is disposed between the beam combining module 30 and the transmission fiber 70 and causes the combined beam L2 emitted from the beam combining module 30 to enter a core of the transmission fiber 70. An example of an element constituting the fifth transmission optical system 52 is a lens group of one or more lenses.

The LD driving power supply 60 supplies the power for driving the LD bars 123 to the LD bars 123 of the laser module 10. The LD driving power supply 60 is connected to the power feeding units 14 of the laser module 10 via the wires 61. The power feeding units 14 electrically connect the wires 61 and the wires 15 inside the laser module 10.

Here, the box 11 of the laser module 10 and the box 31 of a laser combining module include a positioning member for positioning the boxes such that the boxes can be installed at predetermined positions in the laser apparatus 1. The positioning member is a member that is provided on at least one of the box 11 and the box 31 and performs positioning when the box 31 is joined to the beam combining module 30. FIG. 1 illustrates a case where the positioning member is holding faces 21. In the case where the positioning member is the holding faces 21, the holding faces 21 are plate-like members provided to be in contact with the two boxes 11 and 31 at a plurality of positions around a contact surface where the box 11 of the laser module 10 and the box 31 of the beam combining module 30 are in contact with each other. With the holding faces 21 provided, the boxes can be positioned when attached to each other. The positioning member also includes a pin, a keyway, and the like. When the positioning member is the pin, one or more of the pins are provided on a surface of one of the boxes in contact with the other box, and a hole into which the pin is inserted is provided at a position corresponding to the pin on a surface of the other box, whereby the boxes can be positioned when attached to each other. When the positioning member is the keyway, a protrusion called a key extending in one direction is provided on the surface of one of the boxes in contact with the other box, and a groove extending in one direction for allowing the protrusion to be inserted thereinto is provided at a position corresponding to the protrusion on the surface of the other box, whereby the boxes can be positioned when attached to each other.

Similarly, the box 31 of the beam combining module 30 and the box 51 of the fiber coupling module 50 include a positioning member for positioning the boxes such that the boxes can be installed at predetermined positions in the laser apparatus 1. The positioning member may be similar to the positioning member used between the laser module 10 and the beam combining module 30 described above. The example in FIG. 1 illustrates a case where the positioning member is holding faces 41.

Next, an overview of the operation of the laser apparatus 1 having such a configuration will be described. The laser apparatus 1 outputs laser light by the operation of so-called an external resonator. First, the output of the laser beam L1 from one of the LD packages 12 will be described. When the laser beam L1 output from the LD bar 123 of one of the LD packages 12 is made incident on the wavelength dispersion element 33 at a predetermined angle, the laser beam L1 is diffracted at a predetermined angle and travels toward the partially reflective mirror 35. A part of the laser beam L1 is reflected by the partially reflective mirror 35. The reflected laser beam L1 is diffracted in the direction of the original LD bar 123 by the wavelength dispersion element 33. The reciprocation of the laser beam L1 between the reflecting end face of the LD bar 123 and the partially reflective mirror 35 is repeated. Then, only the laser beam L1 having the wavelength that has reciprocated a plurality of times between the reflecting end face of the LD bar 123 and the partially reflective mirror 35, that is, only the laser beam L1 having the optical resonance wavelength is output from the partially reflective mirror 35.

Here, when a plurality of the LD bars 123 is disposed to output the laser beams L1 having different wavelengths together, that is, by wavelength combining, the laser beam L1 having high power can be produced. In this case, in the laser module 10, the placement of the LD packages 12 is adjusted such that the laser beams L1 output from the LD bars 123 become the combined beam L2 having the single optical axis by the wavelength dispersion element 33. That is, the optical axes of the LD bars 123 are adjusted by the placement of the LD packages 12. As a result, the laser beams L1 from all the LD bars 123 diffracted by the wavelength dispersion element 33 become the combined beam L2 having the single optical axis. On the other hand, the combined beam L2 reflected by the partially reflective mirror 35 returns to the original LD bars 123 by the wavelength dispersion element 33.

In the laser apparatus 1 including the LD packages 12 with the plurality of the LD bars 123, the LD bars 123 constituting the LD packages 12 as the laser beam sources generally have lives. The first embodiment proposes a structure assuming the LD bars 123 are replaced.

It is known that the higher the output of the LD bar 123, the more easily the LD bar 123 is affected by the surrounding environment such as dust or dirt. Therefore, in order not to contaminate the LD bar 123, especially the emitting end face thereof, measures such as sealing the periphery of the emitting end face are typically taken. Since the surrounding environment is often poor at the time of component replacement, it is required to contrive to reduce this influence.

In a conventional laser apparatus, the replacement of the LD bar due to the LD bar reaching the end of its life is performed at the site where the laser apparatus is installed. Specifically, after opening the box and replacing the LD bar, the FAC and SAC corresponding to the replaced LD bar need to be adjusted while the shape of the laser beam output from the transmission fiber being observed. In addition, in the conventional laser apparatus, the FAC and the SAC are housed in separate boxes so that the adjustment is performed with the boxes being open. This adjustment work generally takes time. Therefore, during the work on site where the surrounding environment is poor, dirt or the like adheres to the optical component and burns, which can affect the quality of the laser beam. Thus, in the conventional laser apparatus, since the LD bar is replaced and adjusted in the unclean environment having dirt around, there has been a problem that the quality of the laser beam cannot be ensured. The first embodiment provides the laser apparatus 1 capable of replacing the LD bar 123 in a shorter amount of time than the conventional laser apparatus while ensuring the quality of the laser beam L1 under an unclean environment.

Therefore, in the first embodiment, as described above, the laser module 10 is detachable from the beam combining module 30 so that, when the LD bar 123 is replaced due to the LD bar 123 reaching the end of its life, the whole laser module 10 is replaced instead of the LD bar 123.

In addition, the LD bar 123 is usually replaced at the place where the laser apparatus 1 is installed, and the surrounding environment at the time of replacement is not clean. It is assumed that a clean environment refers to a state of the surrounding environment where the density of impurities such as dust or dirt in the ambient environment is lower than a predetermined reference value. In the first embodiment, as described above, the laser module 10 houses the LD packages 12 including the LD bars 123, the first transmission optical systems 13, and the like in the box 11 whose interior is sealed. A new piece of the laser module 10 to be replaced with the laser module 10 subject to replacement is stored in the clean environment until replaced. This can prevent entry of dirt or the like into the interior of the box 11, and the LD bar 123 is not affected by the surrounding environment even in the unclean surrounding environment.

Furthermore, the box 11 of the laser module 10 houses the LD packages 12 including the LD bars 123 and the first transmission optical systems 13 provided for the corresponding LD packages 12 and each including the FAC and the SAC, and, at the time of assembling the laser module 10, the optical axis adjustment between the LD packages 12 and the first transmission optical systems 13 is completed. As a result, at the time of replacing the laser module 10, the optical axis adjustment of the FAC and the SAC does not need to be performed on site, whereby the laser module 10 including the LD bars 123 can be replaced in a shorter amount of time than before.

Specifically, the laser module 10 is performed under the clean environment in which dirt or the like in the air is less than or equal to a predetermined value. Under the clean environment, with a lid of the box 11 being open, the components such as the LD packages 12 and the first transmission optical systems 13 are installed in the box 11, and then adjustment of the installed positions, the angles, and the like of the components is performed. The adjustment is performed such that desired laser characteristics are achieved when the laser module is combined with the beam combining module 30, and the components are fixed after the adjustment. In one example, the adjustment is performed by attaching the laser module 10 to be assembled to a reference beam combining module having the same configuration as the beam combining module 30 illustrated in FIG. 1, or by using a laser beam adjusting jig.

When the laser module 10 is attached to the reference beam combining module, the laser beams L1 are output from the LD bars 123 of the laser module 10 assembled, and the optical axis adjustment is performed while the output and shape of the combined beam L2 from the transmission fiber 70 being observed. In the optical axis adjustment, the angle of emission of the laser beam L1 from the LD bar 123 may be adjusted by rotating the LD package 12 about the reference shaft 124, or the position of the first transmission optical system 13 may be adjusted.

When the laser beam adjusting jig is used, the laser module 10 is installed at a predetermined position, and the optical axis adjustment is performed such that the laser beams L1 from the LD bars 123 are emitted to the laser beam adjusting jig provided at a position corresponding to the position of the wavelength dispersion element 33 of the beam combining module 30. An example of the laser beam adjusting jig is a camera, a hole, or the like provided at a predetermined position.

After the optical axis adjustment is performed, with the laser module 10, the first transmission optical systems 13, and the like being fixed, the lid is closed and sealed so that the interior of the box 11 is sealed. That is, all the LD packages 12 and the corresponding first transmission optical systems 13 have gone through the optical axis adjustment such that the wavelength dispersion element 33 of the beam combining module 30 is irradiated with the laser beams L1 when the laser module 10 is joined to the beam combining module 30. The assembled laser module 10 is stored in the clean environment until replacement occurs. Then, the laser module 10 is transferred to a place where the laser apparatus 1 with the LD bar 123 having reached the end of its life is installed, and replacement is performed on site.

When the laser module 10 is replaced, the wires 61 connected to the power feeding units 14 and the pipes 75 connected to the manifold 16 of the laser module 10 to be replaced in the laser apparatus 1 are detached, and then the laser module 10 is detached from the beam combining module 30. Next, the new piece of the laser module 10 manufactured as described above is joined to the beam combining module 30. At this time, the modules are joined by aligning the positioning member provided on the box 31 of the beam combining module 30 with the positioning member provided on the box 11 of the laser module 10. As a result, the laser module 10 can be joined to the beam combining module 30 while the mechanical position of the laser module 10 with respect to the beam combining module 30 is accurate. After the new laser module 10 is joined to the beam combining module 30, the wires 61 are connected to the power feeding units 14 and the pipes 75 are connected to the manifold 16.

The LD bars 123 and the first transmission optical systems 13 in the laser module 10 have already gone through the optical axis adjustment at the time of assembly, and thus no optical axis adjustment is usually performed after the replacement of the laser module 10. However, due to the replacement of the laser module 10, the input position of the combined beam L2, which is the wavelength-combined beam output from the beam combining module 30, to the transmission fiber 70 needs to be adjusted. Thus, processing is performed in which the laser beams L1 are output from the laser module 10, and the position of the fifth transmission optical system 52 or the transmission fiber 70 is adjusted while the output of the combined beam L2 from the transmission fiber 70 being observed. Alternatively, processing is performed in which the position of the fifth transmission optical system 52 or the transmission fiber 70 is adjusted while measuring a state, such as a state of scattered light at an incident end of the transmission fiber 70, other than the state of the combined beam L2 emitted from the transmission fiber 70. When this adjustment is completed, the replacement of the laser module 10 is completed.

Note that when the beam combining module 30 is assembled, the optical components disposed inside the box 31 are also subject to adjustment under a clean environment so as to achieve desired laser characteristics as in the case of the above laser module 10, and are fixed after the adjustment is completed. The assembled beam combining module 30 is stored in the clean environment until replacement occurs.

Moreover, the beam combining module 30 and the fiber coupling module 50 can each be replaced alone. In this case as well, due to the replacement of the beam combining module 30 or the fiber coupling module 50, the input position of the combined beam L2 output from the beam combining module 30 to the transmission fiber 70 needs to be adjusted. However, the beam combining module 30 and the fiber coupling module 50 are optically and mechanically designed and assembled in advance to the extent that adjustment on the optical components in the modules 30 and 50 does not need to be performed at the time of replacement, whereby the components in the modules 30 and 50 do not need to be adjusted at the time of replacement.

Furthermore, FIG. 1 illustrates only the main components of the laser apparatus 1 of the first embodiment, and does not illustrate components not directly related to the configuration of the first embodiment, but the laser module 10, the beam combining module 30, and the fiber coupling module 50 are provided with not only the optical interfaces but also interface portions for electricity, cooling water, and the like. In one example, although not illustrated, the modules 10, 30, and 50 also include a pipe of a cooling system necessary for cooling, electric wiring of sensors, and the like.

Also, as described above, not only one piece of the laser module 10 but also two or more of the laser modules 10 may be joined to the beam combining module 30.

Note that, in the above description, the windows 112, 311, 312, and 511 are provided at the positions, through which the laser beams L1 pass, on the corresponding boxes 11, 31, and 51 of the laser module 10, the beam combining module 30, and the fiber coupling module 50. However, the windows 112 and 311 provided between the laser module 10 and the beam combining module 30 may be formed as one window and shared by the two boxes 11 and 31, and/or the windows 312 and 511 provided between the beam combining module 30 and the fiber coupling module 50 may be formed as one window and shared by the two boxes 31 and 51.

The laser apparatus 1 according to the first embodiment includes: the laser module 10 including the plurality of the LD packages 12, which includes the LD bars 123 and is fixed to the installation base 111 via the reference shafts 124, and the first transmission optical systems 13 each of which is provided for corresponding one of the LD packages 12, the LD packages 12 and the first transmission optical systems 13 being sealed and housed inside the box 11; the beam combining module 30 that combines the plurality of the laser beams L1 from the laser module 10 into the one combined beam L2; and the fiber coupling module 50 that causes the combined beam L2 from the beam combining module 30 to enter the transmission fiber 70. Each of the modules 10, 30, and 50 is detachable, each of the optical components is assembled under the clean environment in advance so that the desired laser characteristics are achieved when the modules 10, 30, and 50 are brought together, and the interior of each of the boxes 11, 31, and 51 housing the optical components is sealed. Therefore, even when the laser apparatus 1 is installed in a poor surrounding environment, the laser module 10, the beam combining module 30, and the fiber coupling module 50 can be replaced without getting dust or the like in the path of the laser light in the laser module 10. As a result, it is possible to prevent or reduce deterioration or the like due to contamination of the optical components, and to obtain the laser apparatus 1 having high reliability for a long time.

Moreover, in the laser module 10, the LD bars 123 and the first transmission optical systems 13 are adjusted and fixed under the clean environment in advance such that the desired laser characteristics are achieved when the laser module 10 is combined with the beam combining module 30. Therefore, normally, a measuring instrument such as a beam profiler is brought to the site where the laser apparatus 1 is installed to adjust the optical components included in the LD bars 123 and the first transmission optical systems 13, whereas in the first embodiment, the laser module 10 can be replaced without the measuring instrument brought to the site. Moreover, instead of replacing the LD bars 123 individually, the whole laser module 10 is replaced so that a plurality of the LD bars 123 can be replaced in a short amount of time.

The beam combining module 30 uses the WBC system to combine the plurality of the laser beams L1 from the laser module 10 into the one combined beam L2 and output the combined beam L2. That is, the beam combining module 30 includes the wavelength dispersion element 33 such as a diffraction grating, and irradiates the WBC with the laser beams L1 output from direct diode lasers (DDLs) as the plurality of the LD bars 123 of the laser module 10, thereby forming one laser beam L1. In the WBC system, the quality of the beams output from the LD bars 123 is directly associated with the beam quality of a laser oscillator, that is, the laser apparatus 1. However, in the first embodiment, at the time of assembling the laser module 10, the LD packages 12 and the first transmission optical systems 13 are subjected to the optical axis adjustment, so that even after the replacement of the laser module 10, the laser beams L1 of high quality can be immediately output. That is, with the beam combining module 30 using the wavelength dispersion element 33, the laser apparatus 1 having good beam quality is obtained. Moreover, conventionally, at the time of replacing the LD bars 123, the plurality of the LD bars 123 needs adjustment at the installation position where the laser apparatus 1 is installed, whereas in the first embodiment, the laser light having high beam quality can be output without fine optical axis adjustment of the optical components in the laser module 10. Therefore, the first embodiment has an excellent effect compared to the conventional technique.

As described above, according to the first embodiment, it is possible to easily replace the laser module 10 equipped with the plurality of the LD bars 123 constituting the laser beam sources that have limited lives in long-term use of the laser apparatus 1. Also, by assembling and adjusting the laser module 10 in the clean environment, it is possible to reduce a risk such as damage to the optical components due to dirt. Moreover, by storing the laser module 10 in a clean state, work can be performed without allowing intrusion of dirt or the like at the time of replacing the laser module 10 regardless of the environment where the laser apparatus 1 is installed. As a result, the quality of the laser apparatus 1 can be improved.

In addition, the beam combining module 30 also has the structure in which the optical components including the wavelength dispersion element 33 and the partially reflective mirror 35 are sealed inside the box 31. This can prevent dust or the like from entering the beam combining module 30 at the time of replacement of the laser module 10 having a limited life. As a result, the life of the laser apparatus 1 can be prolonged.

### Second Embodiment

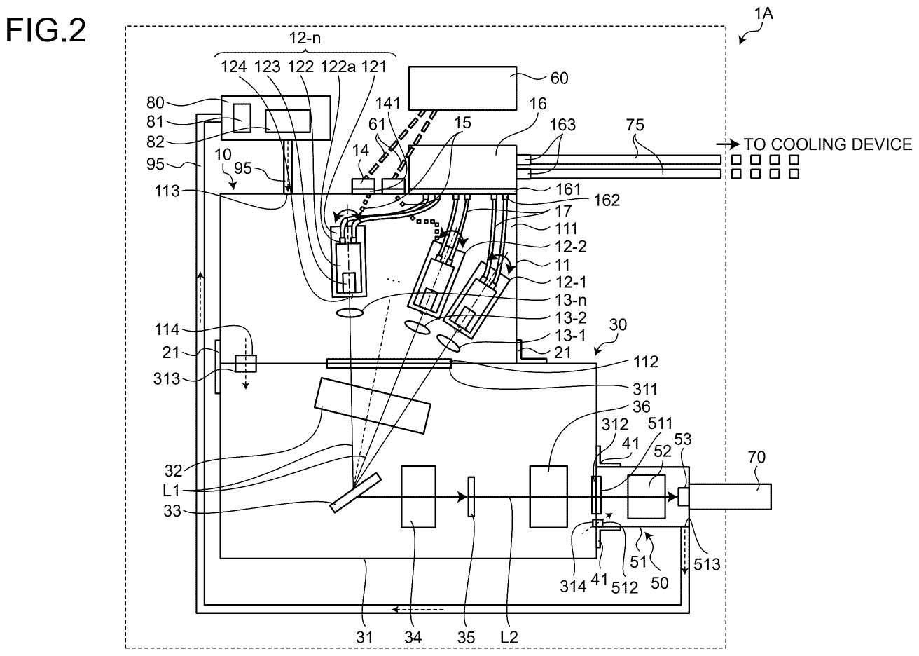

FIG. 2 is a diagram schematically illustrating an example of a configuration of a laser apparatus according to a second embodiment. Note that components identical to those in FIG. 1 are denoted by the same reference numerals as those assigned to such components in FIG. 1, and thus the following will omit the description thereof and describe differences from FIG. 1. A laser apparatus 1A according to the second embodiment further includes a clean air circulation device 80 and air pipes 95, the clean air circulation device 80 circulating clean air, which is cleaned air, inside each of the laser module 10, the beam combining module 30, and the fiber coupling module 50.

The clean air circulation device 80 includes a filter 81 and a circulation pump 82. The filter 81 includes a particle filter capable of removing impurities that are particles in the air, a moisture absorbent for dehumidifying the air, and an organic filter such as activated carbon. The particles in the air include dust, dirt, and the like in addition to the impurities. An example of the circulation pump 82 is a blower. That is, the clean air circulation device 80 is a device that removes the impurities and circulates the dehumidified air among the laser module 10, the beam combining module 30, and the fiber coupling module 50.

The air pipe 95 is a pipe serving as a flow path of the air. The air pipes 95 connect the clean air circulation device 80 to the box 11 of the laser module 10 and connect the clean air circulation device 80 to the box 51 of the fiber coupling module 50. An example of the air pipe 95 is a hose.

The example of FIG. 2 illustrates a configuration in which the laser module 10, the beam combining module 30, the fiber coupling module 50, and the clean air circulation device 80 are connected in series with the air circulating therethrough in order.

The box 11 of the laser module 10 includes an opening 113 on a side surface to which the air pipe 95 is connected, and includes an opening 114 on a side surface connected to the box 31 of the beam combining module 30. The box 31 of the beam combining module 30 includes an opening 313 on a side surface connected to the box 11 of the laser module 10, and includes an opening 314 on a side surface connected to the fiber coupling module 50. The box 51 of the fiber coupling module 50 includes an opening 512 on a side surface connected to the box 31 of the beam combining module 30, and includes an opening 513 on a side surface to which the air pipe 95 is connected.

The opening 114 on the box 11 of the laser module 10 and the opening 313 on the box 31 of the beam combining module 30 are connected. The opening 314 on the box 31 of the beam combining module 30 and the opening 512 on the box 51 of the fiber coupling module 50 are connected. The openings 113, 114, 313, 314, 512, and 513 are each formed by a joint in one example.

When the modules 10, 30, and 50 are moved at the time of replacement thereof, the openings are capped and sealed so that the interior of the modules 10, 30, and 50 can be sealed even during movement thereof. When the modules 10, 30, and 50 are replaced, the openings need only be connected to each other by removing caps of the openings. When the openings are the joints, the joints need only be connected together.

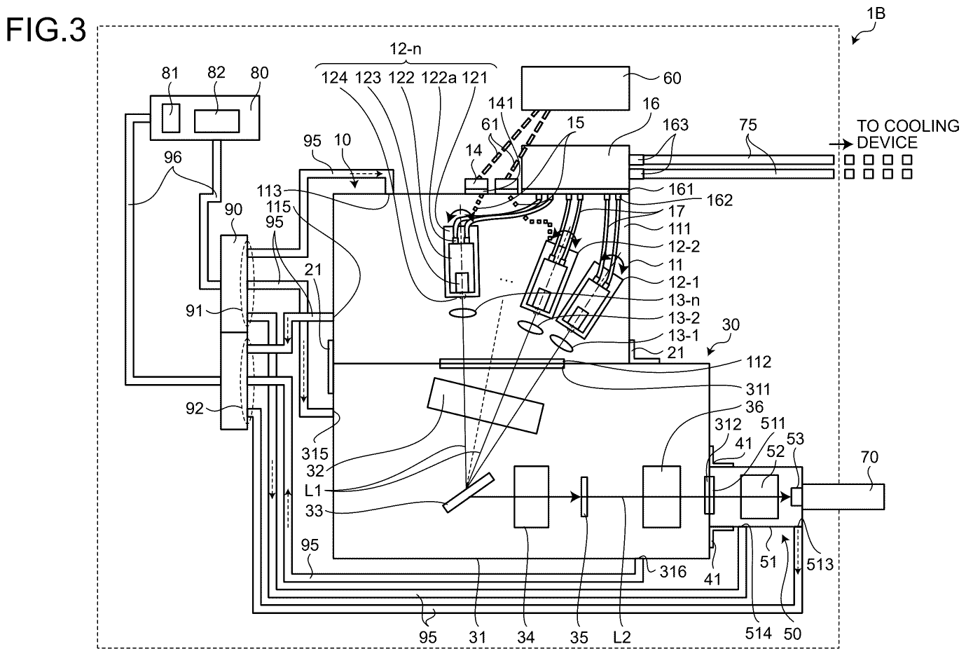

Although FIG. 2 illustrates the example in which the clean air circulation device 80 and the modules 10, 30, and 50 are connected in series, the clean air circulation device 80 and the modules 10, 30, and 50 may be connected in parallel. FIG. 3 is a diagram schematically illustrating another example of the configuration of the laser apparatus according to the second embodiment. Note that components identical to those in FIGS. 1 and 2 are denoted by the same reference numerals as those assigned to such components in FIGS. 1 and 2, and thus the following will omit the description thereof and describe differences from FIGS. 1 and 2. A laser apparatus 1B illustrated in FIG. 3 further includes a buffer device 90. The buffer device 90 is disposed between the clean air circulation device 80 and the modules 10, 30, and 50, and includes internal flow paths that branch the air from the clean air circulation device 80 to be sent to the modules 10, 30, and 50 and merge the air from the modules 10, 30, and 50 to be returned to the clean air circulation device 80. That is, the buffer device 90 includes an outlet 91 from which the air is sent out and an inlet 92 into which the air flows.

In FIG. 3, the box 11 of the laser module 10 includes two openings as the opening 113 and an opening 115 to which the air pipes 95 are connected. The box 31 of the beam combining module 30 includes two openings 315 and 316 to which the air pipes 95 are connected. The box 51 of the fiber coupling module 50 includes two openings as the opening 513 and an opening 514 to which the air pipes 95 are connected. The openings 113, 315, and 514 are connected to the outlet 91 of the buffer device 90, and the openings 115, 316, and 513 are connected to the inlet 92 of the buffer device 90. Moreover, the clean air circulation device 80 and the buffer device 90 are connected by air pipes 96.

In addition to the configurations of FIGS. 2 and 3, the series connection of FIG. 2 and the parallel connection of FIG. 3 may be combined to set up another form of connection.

In the laser apparatuses 1A and 1B, clean and dry air from which the particles have been removed after passing through the filter 81 in the clean air circulation device 80 is discharged to each of the modules 10, 30, and 50 by the circulation pump 82 and is circulated through the path illustrated in FIG. 2 or 3. Then, the air having returned to the clean air circulation device 80 is processed into clean and dry air from which impurities such as dust floating in the air, water vapor, and the like are removed by the filter 81, and is discharged again to each of the modules 10, 30, and 50.

In the laser apparatuses 1A and 1B of the second embodiment, the modules 10, 30, and 50 are connected to the clean air circulation device 80 via the air pipes 95 and 96, and the air is circulated between the modules 10, 30, and 50 and the clean air circulation device 80. Thus, the impurities due to outgas discharged from the components used in the laser module 10, the beam combining module 30, and the fiber coupling module 50 can be removed by the clean air circulation device 80. As a result, it is possible to further prevent or reduce deterioration or the like due to contamination of the optical components, and to obtain the laser apparatuses 1A and 1B having high reliability for a long time.

### Third Embodiment

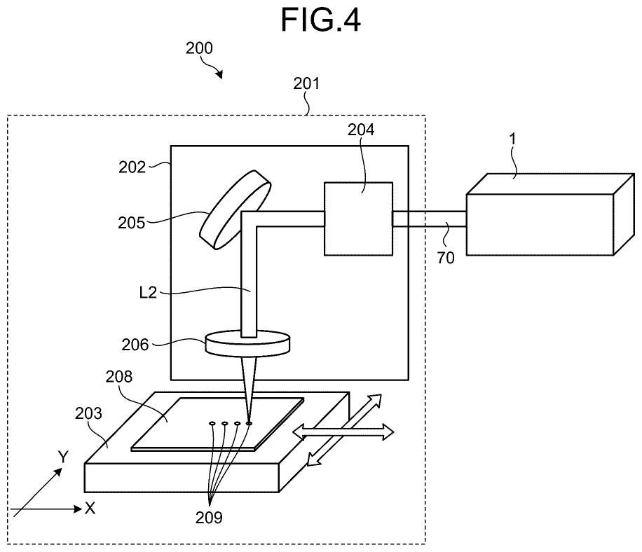

A third embodiment will describe a laser processing machine including the laser apparatus 1, 1A, or 1B according to the first or second embodiment. FIG. 4 is a diagram schematically illustrating an example of a configuration of a laser processing machine according to the third embodiment. A laser processing machine 200 irradiates a workpiece 208 with the combined beam L2 to process the workpiece 208. In the third embodiment, components identical to those in the first or second embodiment are denoted by the same reference numerals as those assigned to such components in the first or second embodiment, and thus the following will omit the description thereof and mainly describe a configuration different from that of the first or second embodiment.

The laser processing machine 200 includes the laser apparatus 1 described in the first embodiment that emits the combined beam L2, the transmission fiber 70 that transmits the combined beam L2 output from the laser apparatus 1, and a processing unit 201 that machines the workpiece 208 with the combined beam L2. Note that the laser apparatus 1 may be the laser apparatus 1A or 1B described in the second embodiment. The transmission fiber 70 is connected between the laser apparatus 1 and the processing unit 201, and transmits the combined beam L2 output from the laser apparatus 1. The processing unit 201 includes a processing head 202 that emits the combined beam L2 toward the workpiece 208, and a stage 203 that supports the workpiece 208. A beam adjustment optical system 204, a mirror 205, and a condenser lens 206 are provided inside the processing head 202. The laser processing machine 200 moves the combined beam L2 and the workpiece 208 relative to each other and irradiates the workpiece 208 with the combined beam L2. In one example, when the workpiece 208 is irradiated with the combined beam L2, fine machined holes 209 are formed at designated positions on the workpiece 208.

The workpiece 208 is, for example, an electronic substrate such as a flexible substrate or a multilayer substrate. These substrates are made of resin and copper foil. The wavelength of the combined beam L2 is preferably a wavelength in the ultraviolet region that can be absorbed by each of the resin and the copper. Note that the workpiece 208 is not limited to the electronic substrate as long as it can be processed using the combined beam L2. The machined hole 209 is, for example, a blind hole or a through hole. A plurality of the machined holes 209 formed in the workpiece 208 may include the machined holes 209 having different sizes. The laser processing machine 200 is not limited to one that forms the machined holes 209, and may be one that performs machining such as marking.

The beam adjustment optical system 204 adjusts the beam diameter and the beam profile of the combined beam L2 emitted from the laser apparatus 1 to desired beam diameter and beam profile that are set in advance. The combined beam L2 having the adjusted beam diameter and beam profile is guided toward the condenser lens 206 by reflection by the mirror 205. The processing head 202 focuses the combined beam L2 on the workpiece 208 using the condenser lens 206.

The laser processing machine 200 moves the stage 203 in a X direction and a Y direction that are directions perpendicular to the center line of the combined beam L2. The X direction and the Y direction are perpendicular to each other. Open arrows illustrated in FIG. 4 indicate the directions in which the stage 203 is moved. The laser processing machine 200 illustrated in FIG. 4 moves the stage 203 with respect to the processing head 202, thereby moving the combined beam L2 and the workpiece 208 relative to each other.

Note that the laser processing machine 200 may move the combined beam L2 and the workpiece 208 relative to each other without moving the stage 203. The laser processing machine 200 may fix the position of the stage 203 and control the incident position of the combined beam L2 on the workpiece 208. In this case, as a configuration for changing the incident position of the combined beam L2, deflection means such as a galvanometer mirror or a polygon mirror may be used. In this case, an Fe lens may be used as the condenser lens 206.

According to the third embodiment, it is possible to easily replace the laser module 10 equipped with the plurality of the LD bars 123 constituting the laser beam sources that have limited lives, in long-term use of the laser apparatus 1, 1A, or 1B. Also, by assembling and adjusting the laser module 10 in a clean environment, it is possible to reduce a risk such as damage to the optical components due to dirt. Moreover, by storing the laser module 10 in a clean state, work can be performed without allowing intrusion of dirt or the like at the time of replacing the laser module 10 regardless of the environment where the laser apparatus 1, 1A, or 1B is installed. As a result, the product quality of the laser processing machine 200 using such a laser apparatus 1, 1A, or 1B can be improved.

The configurations illustrated in the above embodiments each merely illustrate an example so that another known technique can be combined, the embodiments can be combined together, or the configurations can be partially omitted and/or modified without departing from the scope of the present disclosure.

### REFERENCE SIGNS LIST

1, 1A, 1B laser apparatus; 10 laser module; 11, 31, 51 box; 12, 12-1, 12-2, . . . , 12-n LD package; 13, 13-1, 13-2, . . . , 13-n first transmission optical system; 14 power feeding unit; 15, 61 wire; 16 manifold; 17, 75 pipe; 21, 41 holding face; 30 beam combining module; 32 second transmission optical system; 33 wavelength dispersion element; 34 third transmission optical system; 35 partially reflective mirror; 36 fourth transmission optical system; 50 fiber coupling module; 52 fifth transmission optical system; 53 fiber joining portion; 60 LD driving power supply; 70 transmission fiber; 80 clean air circulation device; 81 filter; 82 circulation pump; 90 buffer device; 91 outlet; 92 inlet; 95, 96 air pipe; 111 installation base; 112, 311, 312, 511 window; 113, 114, 115, 313, 314, 315, 316, 512, 513, 514 opening; 121 adjustment member; 122 heat sink; 122a, 162, 163 pipe connection portion; 123 LD bar; 124 reference shaft; 141, 161 seal member; 200 laser processing machine; 201 processing unit; 202 processing head; 203 stage; 204 beam adjustment optical system; 205 mirror; 206 condenser lens; 208 workpiece; 209 machined hole; L1 laser beam; L2 combined beam.

1. A laser apparatus comprising: a laser module to output a plurality of laser beams; and a beam combining module to combine the plurality of the laser beams into a combined beam that is a laser beam having a single optical axis, wherein
the laser module includes:
a plurality of laser beam sources to output the laser beams;
a plurality of first transmission optical systems each of which is provided for corresponding one of the plurality of the laser beam sources to shape each of the laser beams output from the plurality of the laser beam sources into parallel light or a state close to parallel light; and
a first box that houses the plurality of the laser beam sources and the plurality of the first transmission optical systems, and includes a window through which the laser beams output from the plurality of the laser beam sources pass, the first box having sealed interior, wherein
each of the plurality of the laser beam sources includes:
a laser diode bar to output the laser beam;
an adjustment member to fix the laser diode bar; and
a reference shaft to fix the adjustment member on an installation base provided inside the first box, and allow the adjustment member to rotate about an emitting end face of the laser diode bar, and
an orientation of each of the plurality of the laser beam sources on the installation base is set so as to output the laser beam in a predetermined direction, and
each of the plurality of the first transmission optical systems includes:
a first optical component to collimate a fast axis component of the laser beam emitted from the corresponding one of the laser beam sources; and
a second optical component to collimate a slow axis component of the laser beam, and
the plurality of the first transmission optical systems is each fixed to the installation base at a predetermined distance from an emitting end face of the laser diode bar,
the first box is detachable from the beam combining module, and
at least one of the first box or the beam combining module includes a positioning member to position the first box with respect to the beam combining module.

2.-3. (canceled)

4. The laser apparatus according to claim 1, wherein
the beam combining module includes:
a wavelength dispersion element to form the plurality of the laser beams output from the laser module into the combined beam;
a partially reflective mirror to transmit a part of the combined beam; and
a second box that houses the wavelength dispersion element and the partially reflective mirror, and includes a window at each of an input position of the laser beams from the laser module and an output position of the combined beam, the second box having sealed interior.

5. The laser apparatus according to 4 claim 1, further comprising a clean air circulation device to remove impurities and circulate dehumidified air between the laser module and the beam combining module.

6. A laser processing machine comprising:
the laser apparatus according to claim 1; and
a processing device to machine a workpiece with the combined beam.

7. A laser processing machine comprising:
the laser apparatus according to claim 4; and
a processing device to machine a workpiece with the combined beam.

8. A laser processing machine comprising:
the laser apparatus according to claim 5; and
a processing device to machine a workpiece with the combined beam.
